(19) United States
(12) Patent Application Publication
(10) Pub. No.: US 2021/0124690 A1
(43) Pub. Date: Apr. 29, 2021

(54) MEMORY-EFFICIENT VIRTUAL DOCUMENT OBJECT MODEL FOR STRUCTURED DATA

(71) Applicant: ServiceNow, Inc., Santa Clara, CA (US)

(72) Inventors: Fernando Ros, San Marcos, CA (US); Khosrow Jian Motamedi, San Diego, CA (US)

(21) Appl. No.: 16/664,548

(22) Filed: Oct. 25, 2019

(51) Int. Cl. G06F 12/0895; G06F 16/23

(52) U.S. Cl. CPC G06F 12/0895; H04L 63/0272; G06F 16/2379

(57) ABSTRACT

A system may include one or more processors, a non-volatile memory unit storing a sequence of files, and a volatile memory unit storing a partial lexicon. Content within the sequence of files may represent structured data, and elements within the structured data may be uniquely identified by paths. Entries within the partial lexicon may map the paths to the sequence of files and offsets therein identifying the elements that correspond to the paths. Instruction code executable by the processors may cause the system to perform operations including: (i) receiving a specification of a path; (ii) determining that the partial lexicon does not contain a mapping for the path; (iii) obtaining, into the volatile memory unit, supplemental data for the partial lexicon that identifies an element that corresponds to the path; and (iv) providing, for display, storage, or further processing, at least part of the element.

### BACKGROUND

Many markup languages, such as the eXtensible Markup Language (XML), HyperText Markup Language (HTML), and JavaScript Object Notation (JSON), represent textual information as structured data. In general, the data takes form of individual elements, each of which may be primitives (e.g., type-value pairs), arrays, or objects. As arrays and objects can contain primitives as well as other arrays and/or objects, the structured data may be nested in an arbitrarily deep fashion. Any element in the structured data may be uniquely addressable by way of a path that specifies the nesting of zero or more arrays or objects encapsulating the element.

A document object model (DOM) refers to a tree or tree-like in-memory representation of a unit of a markup language (e.g., an XML, HTML, or JSON file). For example, a JSON file may be read into short-term storage (e.g., volatile memory such as main memory) from long-term storage (e.g., non-volatile memory such as a hard disk or solid state disk) or from a network connection. The JSON file may be parsed and stored in a DOM format in the short-term storage. Storing the information as a DOM facilitates searches thereof due to the DOM's tree-like structure.

### SUMMARY

As the size of structured data grows, it becomes inefficient to maintain entire instances of these data and/or their DOMs in main memory. It is now common for XML or JSON files to be 100 megabytes or larger in size. The mere reading of a file of this size from disk storage to main memory and parsing it into a DOM is time-consuming, not to mention that storing the complete DOM representation in main memory would dramatically reduce the amount of this memory that is available to other applications and programs.

Nonetheless, it is desirable to be able to rapidly search structured data (whether it is obtained from files, data streams, or in other manners) in order to find specific elements therein. For searching to be efficient, the DOM representation is preferred over that of the structured data itself, as the former can be searched in logarithmic time while latter would have to be searched in linear time. Thus, having a DOM representation is especially helpful when the structured data is expected to be queried multiple times, as the speed of the queries more than makes up for the overhead of parsing the file into the DOM representation.

The embodiments herein address both memory usage and search efficiency concerns by providing a searchable virtual DOM. Creating a virtual DOM for structured data includes breaking it up into a sequence of fixed-size blocks (which may be individual files or records in a database), and then generating a lexicon of paths to elements therein. Each path may be associated with a block number and an offset therein representing a location at which the element addressed by the path can be found. Thus, searches can be effectively carried out in constant time by implementing the lexicon in an efficiently searchable data structure (e.g., a hash table or hash map).

Nonetheless, such a lexicon can still grow quite large, and can be on the order of the size of the structured data that it indexes. The present embodiments address this issue in at least one of two ways.

In some cases, lexicon entries may only be generated for elements in the structured data that exceed a predetermined size (e.g., 100 bytes, 1 kilobyte, 10 kilobytes). This can reduce the size of the lexicon, in some cases by one or more orders of magnitude, so that it can be more efficiently maintained in main memory. When a path of the structured data is queried, the lexicon is used to locate the associated element. If the queried path is in the lexicon, the lexicon's existing mapping for the queried path can be used to find the element amongst the blocks. If the queried path is not in the lexicon, the longest prefix of the queried path that can be found in the lexicon is used to find an ancestor (e.g., a parent element, a grandparent element, and so on) of the element, and then a DOM of the ancestor and its children is dynamically generated by parsing one or more of the blocks. This partial DOM can be searched to find the element associated with the queried path.

Alternatively, a partial or complete lexicon may be generated, but only parts of it are initially stored in main memory. Particularly, the entries in the lexicon referencing paths of elements at or above a pre-determined nesting depth are stored in main memory, and the rest of the lexicon is stored on disk. The nesting depth represents the number of ancestor elements of a given element. In examples, the nesting depth may be 3, 4, 5, and so on. This can also significantly reduce the amount of main memory used by the lexicon. If a queried path is in the part of the lexicon resident in main memory, that part of the lexicon is used to locate the associated element. If not, the longest prefix of the queried path that can be found in the lexicon is used to find an ancestor element. Then, the parts of the lexicon stored on disk that contain mappings for children thereof are loaded into main memory and used to locate the element associated with the queried path.

Accordingly, a first example embodiment may involve: one or more processors; a non-volatile memory unit storing a sequence of files, wherein content within the sequence of files collectively represents structured data from a file or data stream, and wherein elements within the structured data are uniquely identified by respective paths; a volatile memory unit storing a partial lexicon, wherein entries within the partial lexicon map at least some of the respective paths to the sequence of files and offsets therein, wherein the offsets identify the elements that correspond to the respective paths; and instruction code, stored in the non-volatile memory unit, executable by the one or more processors to cause the system to perform operations that include: (i) receiving a specification of a path; (ii) determining that the partial lexicon does not contain a mapping for the path; (iii) possibly in response to determining that the partial lexicon does not contain the mapping for the path, obtaining, into the volatile memory unit, supplemental data for the partial lexicon, wherein the supplemental data identifies an element that corresponds to the path; and (iv) providing, for display, storage, or further processing, at least part of the element.

A second example embodiment may involve receiving, by a computing system, a specification of a path, wherein a non-volatile memory unit of the computing system stores a sequence of files, wherein content within the sequence of files collectively represents structured data from a file or data stream, wherein elements within the structured data are uniquely identified by respective paths, wherein a volatile memory unit of the computing system stores a partial lexicon, wherein entries within the partial lexicon map at least some of the respective paths to the sequence of files and offsets therein, and wherein the offsets identify the elements that correspond to the respective paths. The second example embodiment may also involve determining, by the computing system, that the partial lexicon does not contain a mapping for the path. The second example embodiment may also involve, possibly in response to determining that the partial lexicon does not contain the mapping for the path, obtaining, by the computing system and into the volatile memory unit, supplemental data for the partial lexicon, wherein the supplemental data identifies an element that corresponds to the path. The second example embodiment may also involve providing, by the computing system for display, storage, or further processing, at least part of the element.

In either embodiment, obtaining the supplemental data may involve: (i) deriving a second path from the path, wherein the second path is a prefix of the path; (ii) mapping, by way of the partial lexicon, the second path to a target file within the sequence of files and a target offset within the target file, wherein the target offset identifies a parent element that contains the element; (iii) generating, from at least the target file or a collection of files, a partial DOM tree for the parent element and all elements contained within the parent element; and (iv) based on the path, finding, within the partial DOM tree, the element. Alternatively or additionally, the supplemental data includes further entries of the partial lexicon that are stored in the non-volatile memory unit, and obtaining the supplemental data involves: retrieving, from the non-volatile memory unit and into the volatile memory unit, a further entry of the partial lexicon containing a mapping from the path to: (i) a particular file of the sequence of files, and (ii) a particular offset within the particular file that identifies the element.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts the structure of a JSON file, in accordance with example embodiments.

FIG. 7A depicts a JSON file, its path structure, and a functionally equivalent XML file, in accordance with example embodiments.

FIG. 7B depicts a conventional DOM representation of the JSON file, in accordance with example embodiments.

FIG. 8 depicts input to and output from a virtual DOM compiler, in accordance with example embodiments.

FIG. 9A depicts a lexicon indexing files in a corpus, in accordance with example embodiments.

FIG. 9B depicts a more memory-efficient lexicon indexing files in a corpus, in accordance with example embodiments.

FIG. 9C depicts another memory-efficient lexicon indexing files in a corpus, in accordance with example embodiments.

FIG. 9D depicts a further memory-efficient lexicon indexing files in a corpus, in accordance with example embodiments.

FIG. 10 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

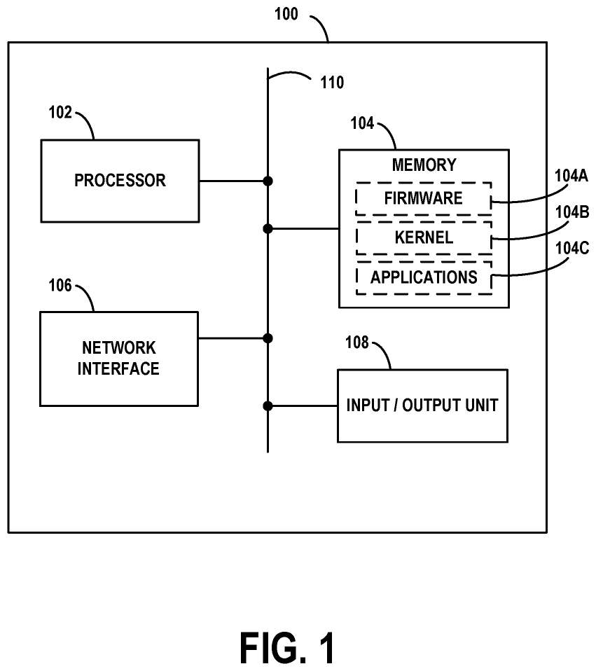

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

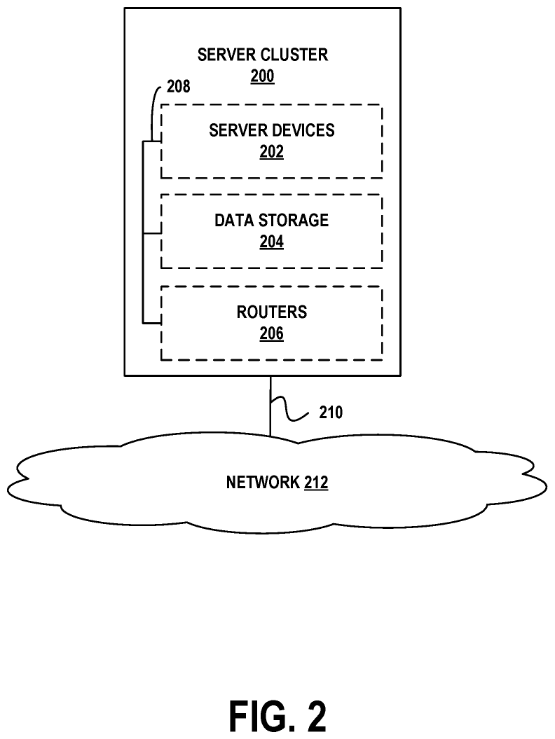

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

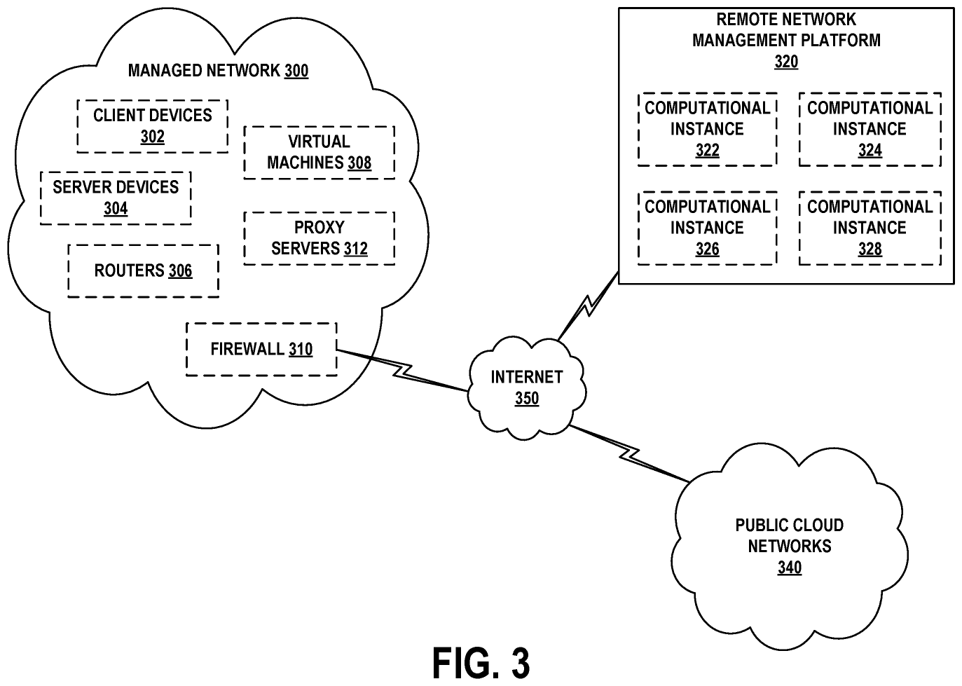

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

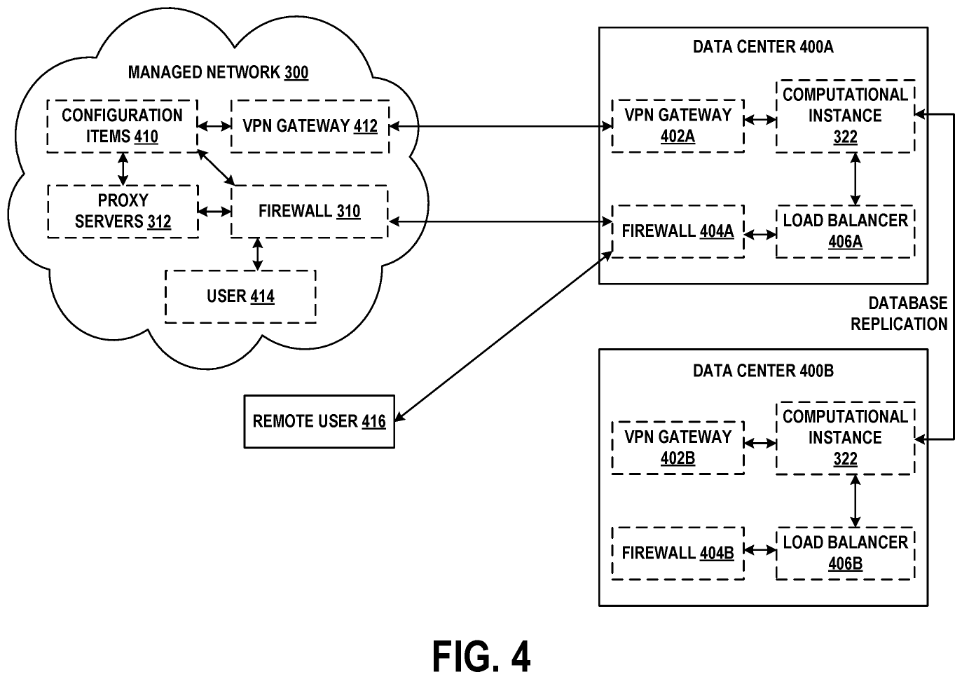

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

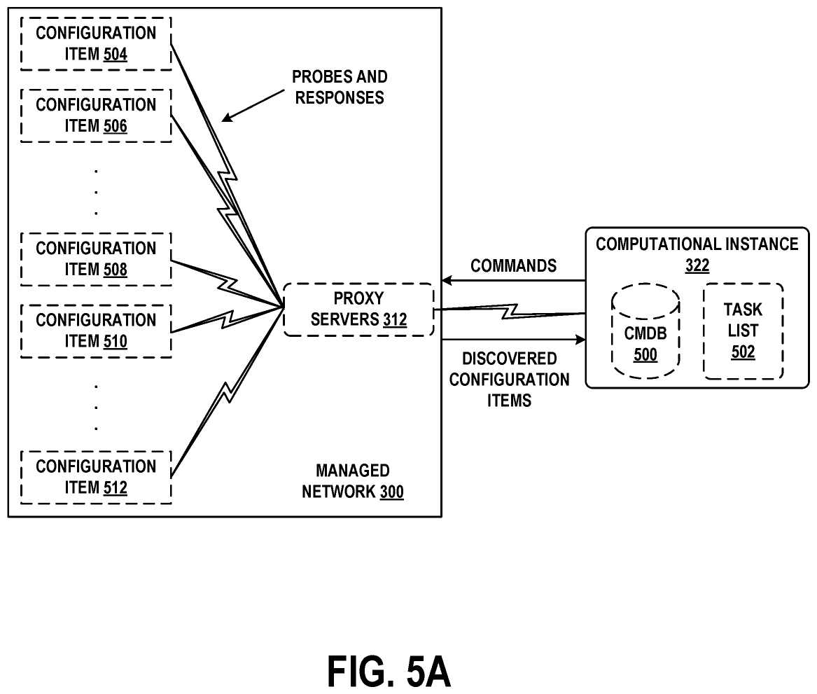

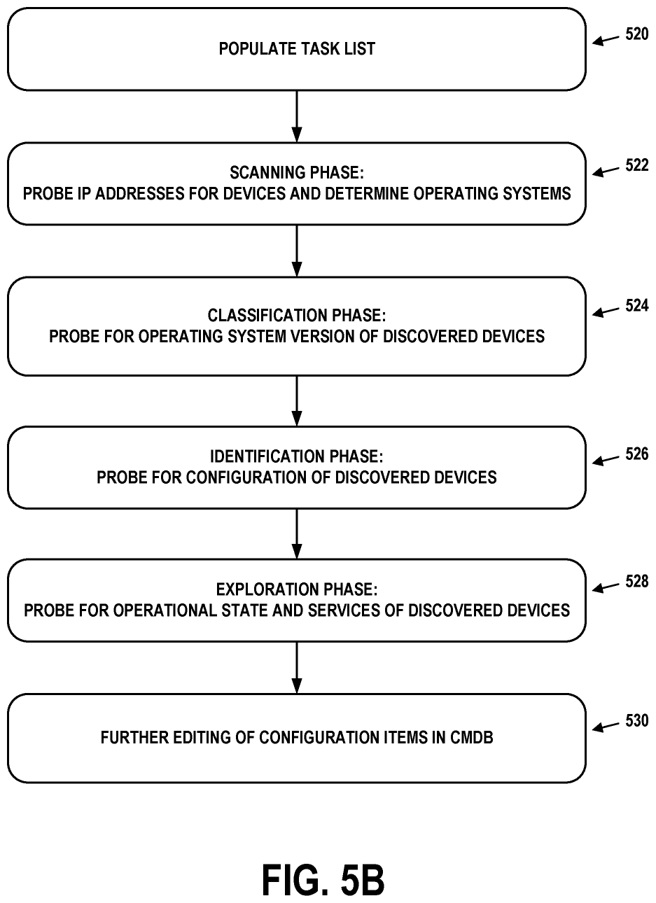

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. JSON and DOM Examples

As noted above, the embodiments herein relate to increasing the efficiency and reducing the memory utilization of textual files encoded in various structured data formats. JSON, an example of such a format, is used herein for purpose of illustration. Nonetheless, the embodiments herein may be used with other types of formats as well (e.g., XML or HTML). JSON is commonly used to format textual information that is communicated between a web client and web server, such as in representational state transfer (REST) transactions. But JSON can also be used for inter-application communication in general, between applications on the same computing device and/or between two or more computing devices.

JSON supports recursive hierarchical nesting of objects and arrays. A JSON object is an unordered set of key-value pair elements that begins with a left brace (“{”) and ends with a right brace (“}”). Each key-value pair element in an object is separated by a comma. JSON arrays are ordered sets of value elements that begin with a left bracket (“[”) and end with a right bracket (“]”). The value elements in an array are separated by commas. Value elements may be character strings, numbers, Boolean values, or null values, as well as objects or arrays (thus enabling the recursive hierarchical nesting). The key part of a key-value pair element is also a character string. Any amount of whitespace can be placed between these items.

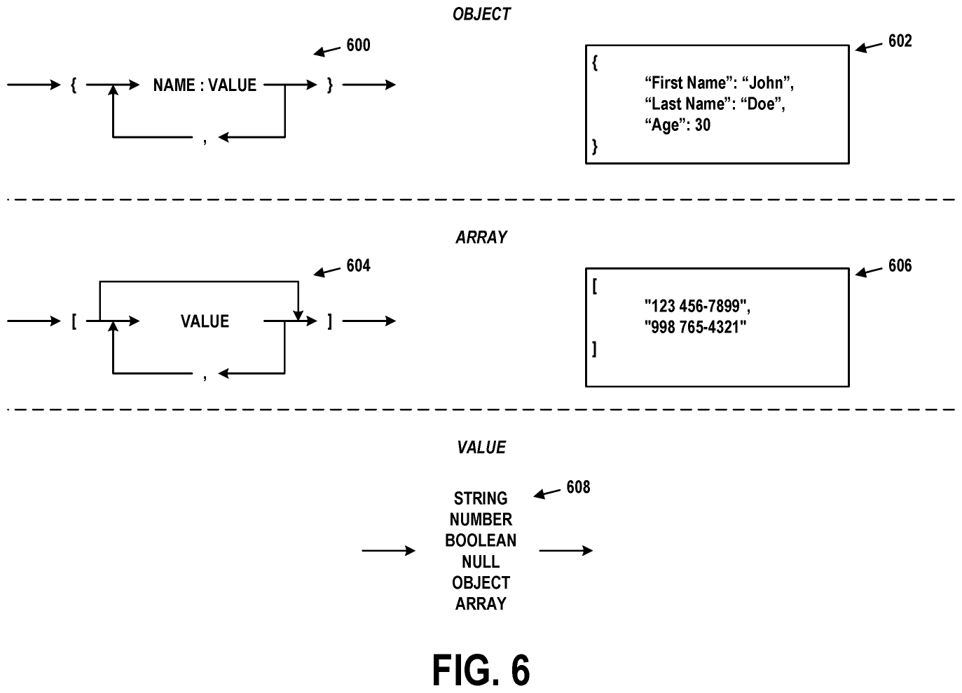

FIG. 6 depicts formal language definitions and associated examples of JSON. Diagram 600 provides a formal definition of an object, diagram 604 provides a formal definition of an array, and diagram 608 provides a formal definition of a value element. Example 602 is of an object containing three key-value pair elements for the first name, last name and age, respectively, of an individual. Example 606 is of an array containing two value elements for phone numbers. Both of these examples are fully encapsulated by braces and brackets, respectively. Thus, they are completely defined and may be referred to as records. In other words, records in JSON files are delimited by an open brace and a corresponding close brace, or an open bracket and a corresponding close bracket. Objects, arrays, values, and/or any combination thereof may be referred to as elements.

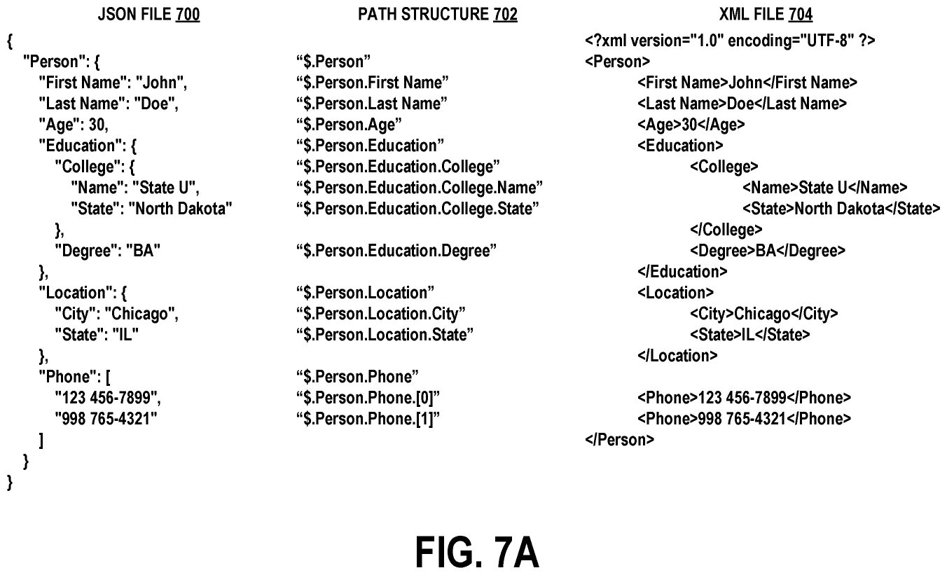

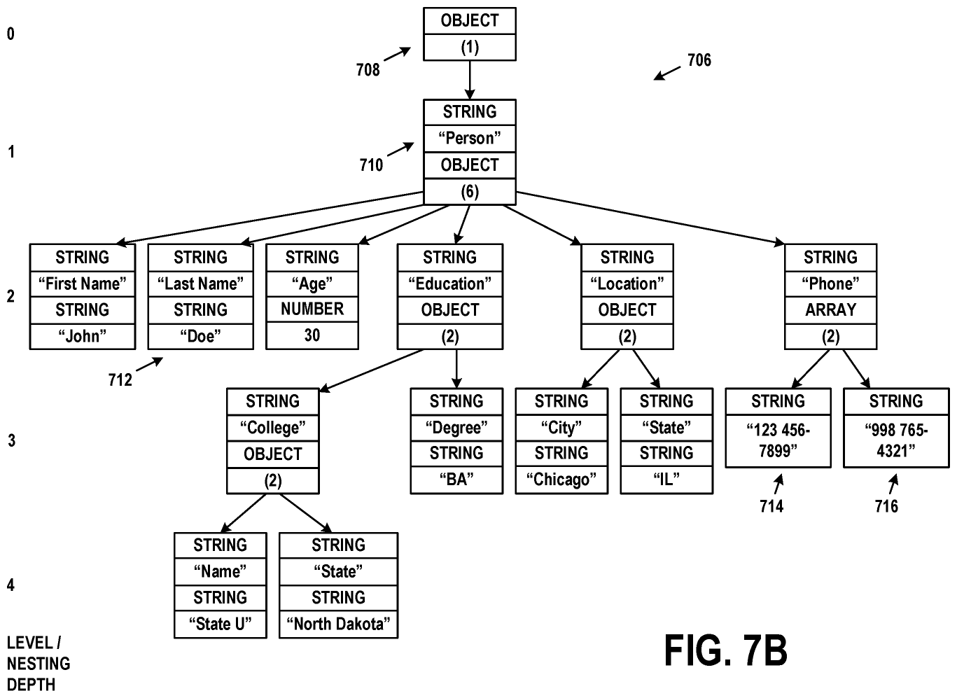

Elements within a record can be uniquely identified by a path. The path may be represented as a concatenation of the nested objects and arrays that can be used to locate a specific element within the JSON file. For instance, in FIG. 7A, JSON file 700 defines a “Person” object with various nested objects and arrays. Path structure 702 defines the corresponding paths for each, object, array, and value in JSON file 700. For instance, the person's first name (“John”) can be found at “$.Person.First Name”, the person's age (30) can be found at “$.Person.Age” and the person's degree (“BA”) can be found at “$.Person.Education.Degree”. In this syntax, a path always begins with “$.” and element names (keys) are separated by a “.”. Further, arrays are indexed in brackets surrounding numbering that begins at 0 (e.g., “$.Person.Phone.[0]” and “$.Person.Phone.[1]”).

For sake of illustration, FIG. 7A also includes XML file 704, which is functionally equivalent to JSON file 700, and when parsed would also result in path structure 702. XML file 704 demonstrates that the embodiments herein can operate equally well on XML even though JSON is used for purposes of example.

FIG. 7B depicts a conventional DOM representation 706 of JSON file 700 (and XML file 704). In particular, DOM representation 706 is in a tree form, each node of which represents an element of JSON file 700. There is a one-to-one-to-one mapping between elements in JSON file 700, their paths, and nodes in DOM representation 706.

Primitives are represented in leaf nodes with key-value pairs. For example, node 712 represents the key-value pair of “Last Name”: “Doe” from JSON file 700. The exception is that elements of an array, such as those represented by nodes 714 and 716, contain only values.

Objects and arrays are represented as non-leaf (intermediate) nodes with keys therein and values that refer to one or more child nodes. For example, node 708 represents the entire object encoded by JSON file 700, notably the information between the outermost pair of braces. As these braces contain a single object, node 708 indicates such and has a single child, node 710. Node 710, on the other hand, represents the “Person” object which has 6 elements. Thus, node 710 has six children, one for each of these elements.

To the left of DOM representation 706 is a labeling of the levels in the tree. These levels represent the depth of the nodes, which is related to the nesting depth of the elements. For example, node 708 is at level 0 (no ancestor elements), node 710 is at level 1 (1 ancestor element), node 712 is at level 2 (2 ancestor elements), nodes 714 and 716 are at level 3 (3 ancestor elements), and so on. These levels map to sections of the paths in path structure 702. For example, level 0 maps to “$”, level 1 maps to “Person”, level 2 maps to “$.Person.First Name”, “$.Person.Last Name”, “$.Person.Age”, “$.Person.Education”, “$.Person.Location”, and “$.Person.Phone”, and so on.

### VI. Memory-Efficient Virtual DOM Structures

As noted previously, maintaining a large DOM in main memory can be cumbersome, especially if that DOM is many megabytes in size. This results in less main memory being available for other applications and programs, which is problematic in a remote network management platform where computational resources are shared between users within an enterprise, and in some cases between enterprises. Thus, reducing memory-resident DOM size will result in an improvement to the operation of the remote network management platform as well as the computational devices that host the remote network management platform.

Throughout the discussion herein, data may be referred to as being stored in a file, read from a file, or written to a file. While file-based storage and file-based I/O encompass some possible embodiments, other embodiments, including data streaming I/O and database storage and I/O, may be used instead. Thus, the implementations discussed are not restricted to using files, even though use of files is described for purposes of illustration.

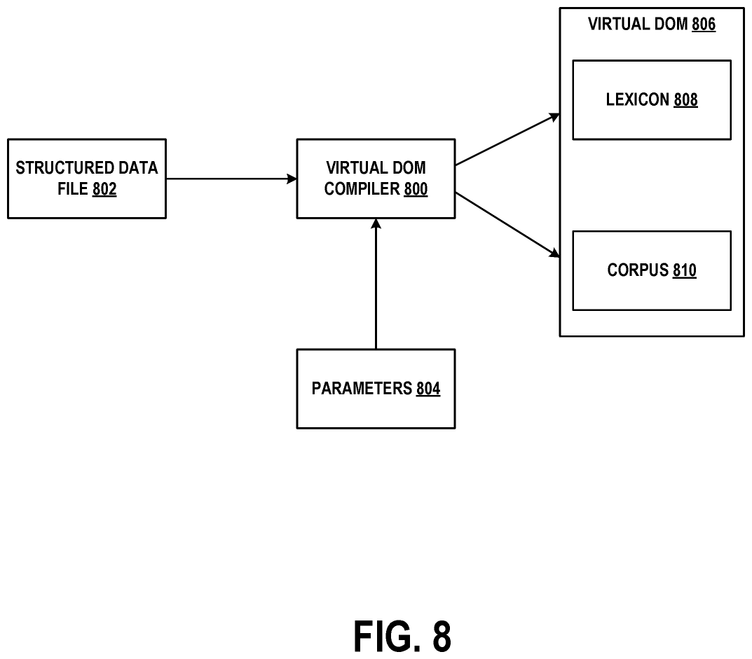

FIG. 8 illustrates a virtual DOM compiler 800. It receives as input structured data file 802 and parameters 804. As output, virtual DOM compiler 800 produces virtual DOM 806, which includes lexicon 808 and corpus 810. Corpus 810 is a representation of structured data file 802 (e.g., JSON file 700) divided into blocks. Each block may be stored in long-term memory (e.g., on disk) as a separate file. Lexicon 808 is an index into corpus 810 that maps paths that reference elements in structured data file 802 to where those elements reside in corpus 810.

Notably, the virtual DOM need not be in the tree or tree-like form of a conventional DOM, though parts of it may—at least temporarily—be represented as a tree. Further, the size of each block in the corpus can vary and may be user-configurable. Sizes such as 4, 8, 16, 32, 64, 128, or 256 kilobytes are possible, as are other sizes.

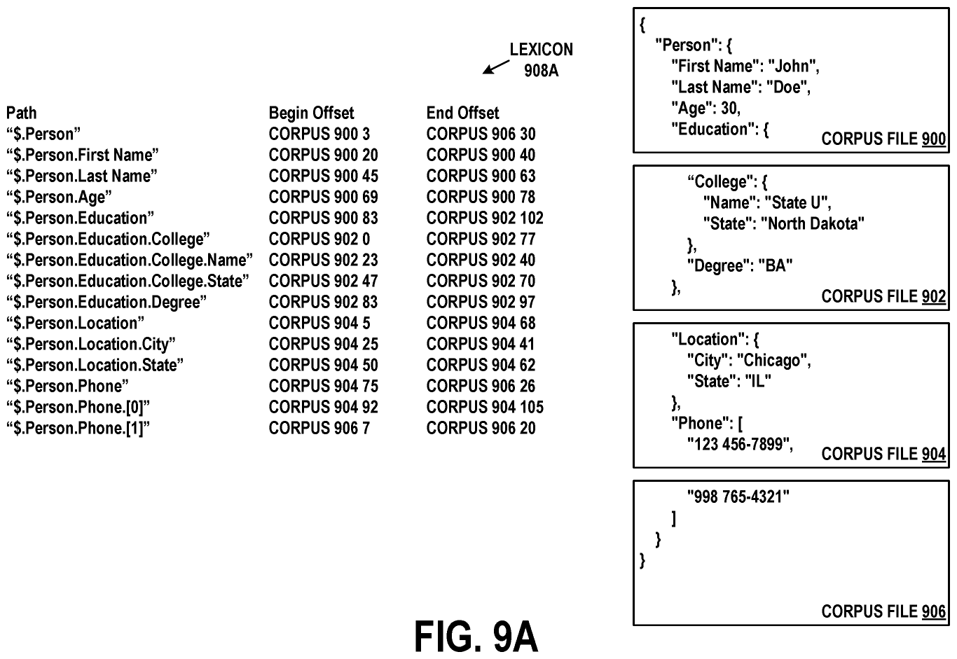

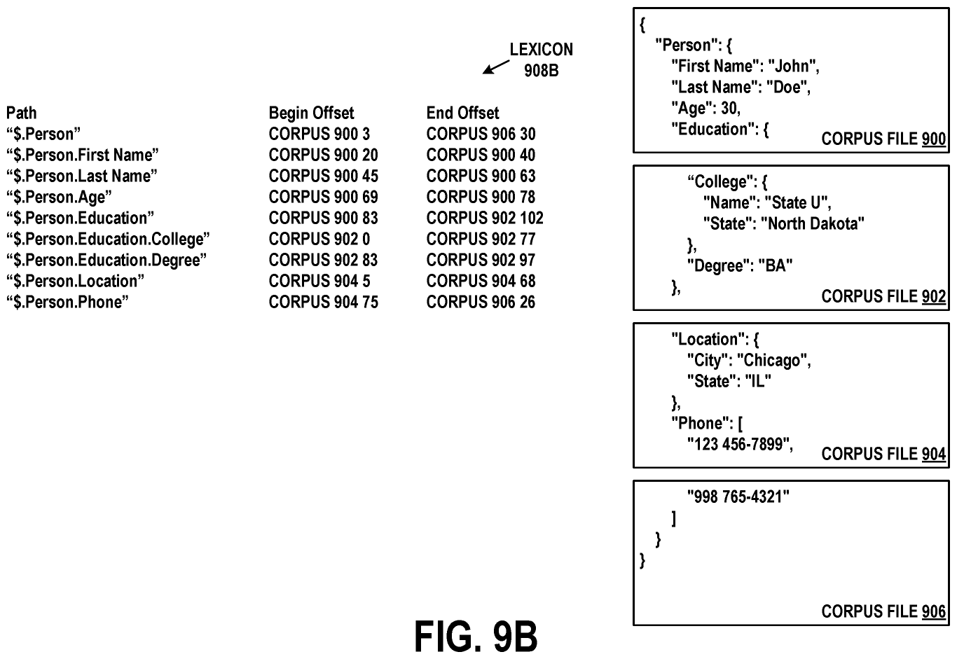

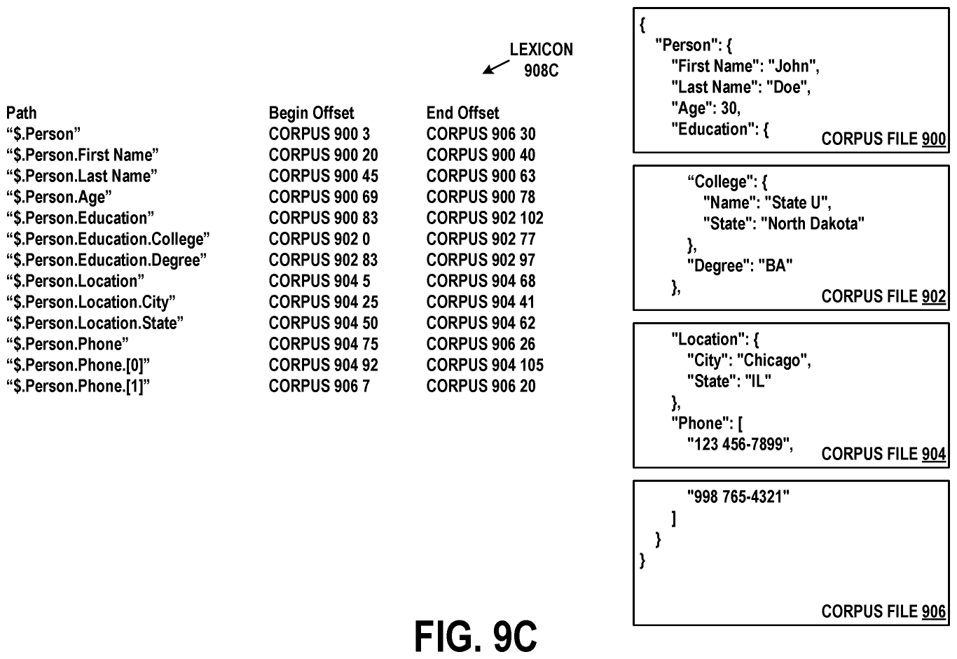

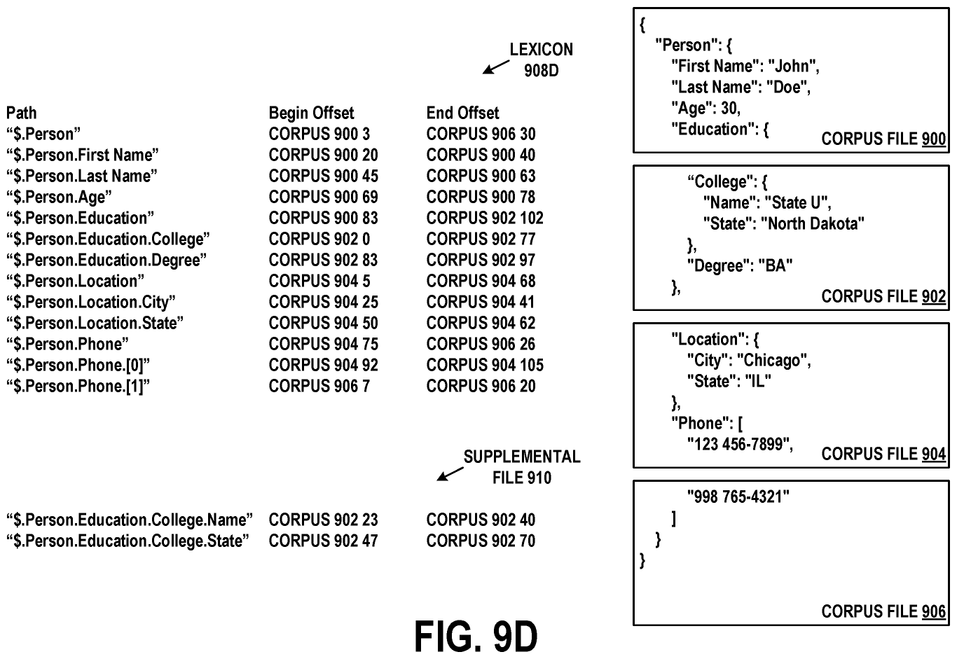

Structural examples of such a lexicon and corpus are shown in FIG. 9A. Here, JSON file 700 is used as the structured data file, for purposes of example. The corpus has been configured with a block size of 100 bytes in order to illustrate how a structured data file can be divided into blocks. In some examples, a large structured data file and larger block size may be used. For example, a 100 megabyte file (consisting of 104857600 bytes) can be divided into 800 corpus files each 128 kilobytes in size. Regardless, JSON file 700 is divided into four blocks, corpus file 900, corpus file 902, corpus file 904, and corpus file 906. Each of these blocks may be a separate file stored in non-volatile memory. Although each JSON element neatly falls into a specific block in this example, elements may be split across block boundaries in other examples.

Lexicon 908A provides a number of entries, one for each path in JSON file 700. Each entry maps its path to two offsets in the corpus that represent respective locations. The begin offset indicates the corpus file and location therein where the element associated with the path begins and the end offset indicates the corpus file and location therein where the element associated with the path ends. These offsets may also be referred to as block indexes and locations within those blocks.

As an example, the path “$.Person.Age” is associated with the element “Age”, which begins at byte 69 of corpus file 900 and ends at byte 78 in the same file. Likewise, path “$.Person.Education.College” is associated with the element “College”, which begins at byte 0 of corpus file 902 and ends at byte 77 in the same file. In some cases, an element can span multiple corpus files. An example of this is the element “Education” that is associated with the path “$.Person.Education”. This element begins at byte 83 in corpus file 900 and ends at byte 102 in corpus file 902. In some cases the ending offset is not required and the begin offset may be the only offset recorded in lexicon 908A.

Lexicon 908A is constructed by parsing through the corpus files, one by one and in order, and recording the beginning and ending byte offset and corpus file of each element therein. Once lexicon 908A is constructed, an element can be found in the corpus files by searching lexicon 908A for its path, and then using the associated begin offset to find the element within the indicated corpus file. From there, the entire element, or just the value thereof, may be returned.

For example, a user may enter the path “$.Person.Age” or such a path may be contextually derived from other input from the user (e.g., the user may select a visual indication of the path by way of a user interface). This path may be searched in lexicon 908A until its entry is found. As the entry indicates that the element begins at byte 69 of corpus file 900, this file may be accessed at byte 69 to locate the element. Then, the element is read from the file and some or all of it may be returned. For example, in some cases just the value “30” may be returned.

In order to facilitate efficient searching for paths in lexicon 908A, a hash table or hash map may be used to store the paths. Thus, the expected lookup time becomes constant—i.e., O(1) time to find the target entry in lexicon 908A and to use this entry to locate the element in the corpus files. Other data structures may be used to provide similarly efficient lookups.

In various embodiments, lexicon 908A may be resident in volatile memory (e.g., main memory), while the corpus files may be stored in non-volatile memory (e.g., disk) as described above. This facilitates a rapid lookup time as lexicon 908A does not need to be read into volatile memory in order for the search to commence. Nonetheless, despite the advantages implementing a virtual DOM using a lexicon and corpus as described herein, a large lexicon can still tax the volatile memory resources of modern computing systems. For example, a lexicon with millions of entries can be several megabytes in size. Maintaining such a large amount of data in volatile memory can be inefficient, causing other programs to slow or be unable to operate properly. Thus it is desirable to be able to store less than the whole lexicon in volatile memory at any given point in time. The embodiments herein provide several distinct ways of achieving this goal of reducing memory utilization. These embodiments may be combinable in various ways.

As noted above, parameters 804 may control how the lexicon and corpus are created and managed. One of these parameters may be an element size threshold, measured in bytes. Array or object elements that have fewer bytes than this threshold may be omitted from the lexicon (alternatively, just the size of the value portion may be compared to the threshold). The lexicon may still contain an entry for the element, but no entries for child elements thereof.

As an example, consider lexicon 908A and corpus files 900, 902, 904, and 906. Suppose that the element size threshold is 100 bytes. Of the arrays and objects in JSON file 700, those associated with the paths “$.Person.Education.College”, “$.Person.Location”, and “$.Person.Phone” are each under 100 bytes in length. Therefore any child paths thereof are omitted from the lexicon. This is shown in FIG. 9B, where lexicon 908B represents lexicon 908A with these paths omitted. The lexicon has shrunk from 15 entries to 9 entries, a reduction of size on the order of 40%. In large JSON files with other structures, this reduction can easily be greater than 40%.

In order to search for an element that is not represented by a path in such a lexicon, the following procedure may be used. The lexicon is searched for the queried path as described above. When the queried path is not found, it is determined that a parent path of the queried path is to be constructed. This parent path is the longest prefix of the queried path formed by removing the rightmost element from the queried path. In other words, if “$.Person.Education.College” is the queried path, the parent path is “$.Person.Education”. Then the parent path is searched. If the parent path is not found in the lexicon, its parent path is constructed and searched. This process can be repeated recursively some number of times.

Eventually, a prefix path is found in the lexicon. This prefix path is associated with an element that is an ancestor (e.g., a parent) of the element that is sought after. Given that the lexicon provides the location of the beginning byte (and possibly the ending byte) of this ancestor element, the ancestor element can be retrieved. Then a conventional DOM (e.g., in line with the example DOM of FIG. 7B) for just the ancestor element is constructed. This dynamically constructed DOM is then searched for the element that is sought after (i.e., the element associated with the queried path). That element is then returned. After the element is returned, the dynamically constructed DOM may be deleted or may be cached for some period of time.

Since the dynamically constructed DOM represents a relatively small portion of the elements in the JSON file, it can be generated quite rapidly and with a bounded number of operations. Therefore, the virtual DOM embodiments herein can dramatically reduce the memory requirements of the lexicon without significantly impacting the execution time for searches.

In additional or alternative embodiments, parameters 804 may include a nesting threshold. This threshold indicates a nesting depth beyond which arrays or objects are not initially included in the lexicon. For example, if the nesting threshold is 4, an element that is nested within at least four ancestor elements may be omitted from the lexicon.

As an example, again consider lexicon 908A and corpus files 900, 902, 904, and 906. Suppose that the nesting threshold is 4. Of the arrays and objects in JSON file 700, those associated with the paths “$.Person.Education.College.Name” and “$.Person.Education.College.State” are each at a nesting level of 4. Therefore, any paths thereof are omitted from lexicon 908A. This is shown in FIG. 9C as lexicon 908C. The lexicon has shrunk from 15 entries to 13 entries, a reduction of size on the order of 13%. In large JSON files with other structures, this reduction can easily be significantly greater than 13%. Regardless, a conventional DOM can be constructed and searched in a fashion similar to that of lexicons subject to an element size threshold.

In further embodiments, a lexicon may be fully constructed, but parts of it may be initially stored in volatile memory and the remaining parts stored in non-volatile memory. For example, lexicon entries associated with elements that have a nesting level of up to and including 3 may be initially placed in main memory while lexicon entries associated with elements at or beyond a nesting level of 4 may be initially stored in files on disk. A lexicon entry for an array or object with child elements stored on disk may include a reference to a supplemental file in which its child elements can be found.

An example for JSON file 700 and a nesting level of 4 is shown in FIG. 9D. Lexicon 908D is identical to lexicon 908C, while supplemental file 910 contains lexicon entries for elements 4 or more nesting levels deep in JSON file 700. When a queried path is searched for in lexicon 908D and not found, an ancestor path is determined as described above. Then, the reference to supplemental file 910 (which is associated with this ancestor path) is read into main memory and the element associated with the queried path is searched for therein. In various other examples, more supplemental files may be present.

Supplemental files dynamically loaded into main memory in this fashion may be deleted from main memory immediately after use, or may remain in main memory for some period of time. There may be one or more limits on the number of such supplemental files or the total size of such supplemental files that can be held in main memory concurrently. When new supplemental files are loaded into main memory other supplemental files resident in main memory may be removed therefrom to maintain this limit. For example, the least recently used or least frequently used supplemental file may be deleted from main memory (though a copy of this file may still exist on disk). Other examples are possible.

### VII. Example Operations

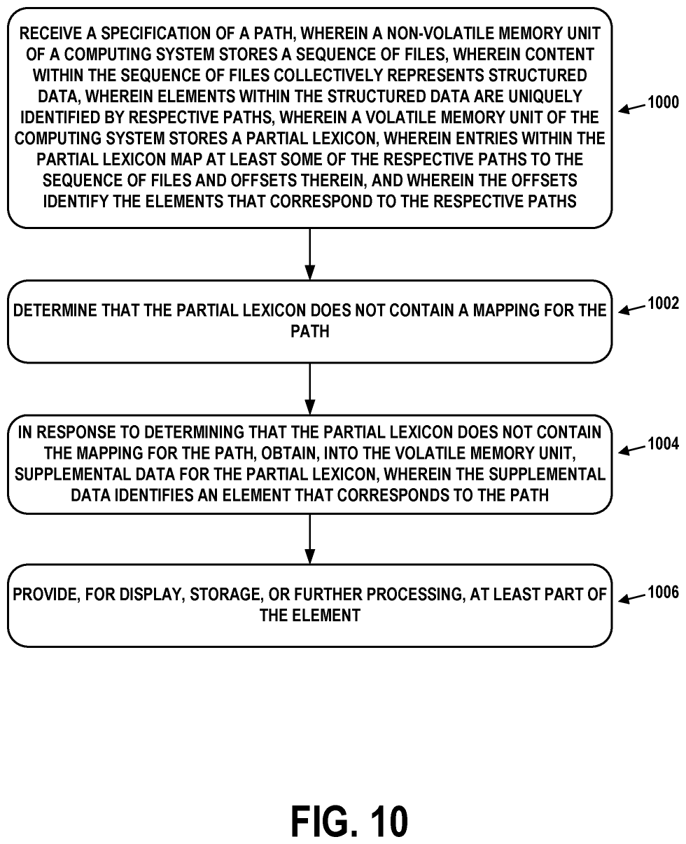

FIG. 10 is a flow chart illustrating an example embodiment. The process illustrated by FIG. 10 may be carried out by a computing device, such as computing device 100, and/or a cluster of computing devices, such as server cluster 200 (e.g., hosting computational instance 322). However, the process can be carried out by other types of devices or device subsystems. For example, the process could be carried out by a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1000 involves receiving a specification of a path, wherein a non-volatile memory unit of the computing system stores a sequence of files, wherein content within the sequence of files collectively represents structured data (e.g., from a file or a data stream), wherein elements within the structured data are uniquely identified by respective paths, wherein a volatile memory unit of the computing system stores a partial lexicon, wherein entries within the partial lexicon map at least some of the respective paths to the sequence of files and offsets therein, and wherein the offsets identify the elements that correspond to the respective paths.

Block 1002 involves determining that the partial lexicon does not contain a mapping for the path. For example, a hash table or hash map containing all paths in lexicon may be searched without finding the path.

Block 1004 involves, possibly in response to determining that the partial lexicon does not contain the mapping for the path, obtaining, into the volatile memory unit, supplemental data for the partial lexicon, wherein the supplemental data identifies an element that corresponds to the path.

Block 1006 involves providing, by the computing system for display, storage, or further processing, at least part of the element. For example a value of the element may be transmitted to a client device for display, stored in a database or file, or given to another application that uses the value in some fashion.

In some embodiments, the offsets include, for each respective element, a begin offset and an end offset, the begin offset indicates a first byte where the respective element begins in a first file of the sequence of files, and the end offset indicates a second byte where the respective element ends in a second file of the sequence of files. In some cases, the first file and the second file are different, while in others the second file is the first file.

In some embodiments, the structured data contains text formatted according to JSON, XML, or HTML. Other formats are possible.

In some embodiments, obtaining the supplemental data comprises: (i) deriving a second path from the path, wherein the second path is a prefix of the path; (ii) mapping, by way of the partial lexicon, the second path to a target file within the sequence of files and a target offset within the target file, wherein the target offset identifies a parent element that contains the element; (iii) generating, from at least the target file, a partial DOM tree for the parent element and all elements contained within the parent element; and (iv) based on the path, finding, within the partial DOM tree, the element. Entries for the elements that are of a size less than a pre-determined threshold number of bytes might not be initially stored in the partial lexicon.

These embodiments may also involve, prior to receiving the specification of the path: (i) parsing the sequence of files to identify the elements therein, (ii) for each particular element identified, determining whether a particular size of the particular element is less than the pre-determined threshold number of bytes, and (iii) if the particular size of the particular element is not less than the pre-determined threshold number of bytes, creating a new entry in the partial lexicon for the particular element, wherein the new entry includes a particular path that identifies the particular element within the structured data, a particular file of the sequence of files in which the particular element is disposed, and a particular offset within the particular file at which the particular element is found. These embodiments may also involve after providing the element, deleting the partial DOM tree. These embodiments may also involve, based on information in the partial DOM tree and the sequence of files, adding a further entry to the partial lexicon that maps the path to: (i) a particular file of the sequence of files, and (ii) a particular offset within the particular file that identifies the element.

In some embodiments, the supplemental data comprises further entries of the partial lexicon that are stored in the non-volatile memory unit, and wherein obtaining the supplemental data involves retrieving, from the non-volatile memory unit and into the volatile memory unit, a further entry of the partial lexicon containing a mapping from the path to: (i) a particular file of the sequence of files, and (ii) a particular offset within the particular file that identifies the element. The further entries of the partial lexicon may be stored in the non-volatile memory unit based on the further entries of the partial lexicon being associated with paths that identify elements that are nested within more than a threshold number of parent elements. The threshold number of parent elements (e.g., the nesting level) may be within a range of 2 to 4, but other values are possible. Retrieving the further entry may involve: (i) determining that the path indicates that the element is nested within more than the threshold number of parent elements; and (ii) possibly in response to determining that the path indicates that the element is nested within more than the threshold number of parent elements, reading, from the non-volatile memory unit and into the volatile memory unit, a lexicon file that contains the further entry. Some embodiments may also involve after providing the element, deleting the further entry from the volatile memory unit.

In some embodiments the volatile memory unit is a main memory unit, and the non-volatile memory unit is a disk-based memory unit.

### VIII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
one or more processors;
a non-volatile memory unit storing a sequence of files, wherein content within the sequence of files collectively represents structured data from a file or data stream, and wherein elements within the structured data are uniquely identified by respective paths;
a volatile memory unit storing a partial lexicon, wherein entries within the partial lexicon map at least some of the respective paths to the sequence of files and offsets therein, wherein the offsets identify the elements that correspond to the respective paths; and
instruction code, stored in the non-volatile memory unit, executable by the one or more processors to cause the system to perform operations that include:
receiving a specification of a path;
determining that the partial lexicon does not contain a mapping for the path;
in response to determining that the partial lexicon does not contain the mapping for the path, obtaining, into the volatile memory unit, supplemental data for the partial lexicon, wherein the supplemental data identifies an element that corresponds to the path; and
providing, for display, storage, or further processing, at least part of the element.

2. The system of claim 1, wherein the offsets include, for each respective element, a begin offset and an end offset, wherein the begin offset indicates a first byte where the respective element begins in a first file of the sequence of files, and wherein the end offset indicates a second byte where the respective element ends in a second file of the sequence of files.

3. The system of claim 2, wherein the second file is the first file.

4. The system of claim 1, wherein the structured data contains text formatted according to JavaScript Object Notation (JSON), eXtensible Markup Language (XML), or HyperText Markup Language (HTML).

5. The system of claim 1, wherein obtaining the supplemental data comprises:
deriving a second path from the path, wherein the second path is a prefix of the path;
mapping, by way of the partial lexicon, the second path to a target file within the sequence of files and a target offset within the target file, wherein the target offset identifies a parent element that contains the element;
generating, from at least the target file, a partial document object model (DOM) tree for the parent element and all elements contained within the parent element; and
based on the path, finding, within the partial DOM tree, the element.

6. The system of claim 5, wherein the entries for the elements that are of a size less than a pre-determined threshold number of bytes are not initially stored in the partial lexicon.

7. The system of claim 6, wherein the operations also include:
prior to receiving the specification of the path: (i) parsing the sequence of files to identify the elements therein, (ii) for each particular element identified, determining whether a particular size of the particular element is less than the pre-determined threshold number of bytes, and (iii) if the particular size of the particular element is not less than the pre-determined threshold number of bytes, creating a new entry in the partial lexicon for the particular element, wherein the new entry includes a particular path that identifies the particular element within the structured data, a particular file of the sequence of files in which the particular element is disposed, and a particular offset within the particular file at which the particular element is found.

8. The system of claim 5, wherein the operations also include:
after providing the element, deleting the partial DOM tree.

9. The system of claim 5, wherein the operations also include:
based on information in the partial DOM tree and the sequence of files, adding a further entry to the partial lexicon that maps the path to: (i) a particular file of the sequence of files, and (ii) a particular offset within the particular file that identifies the element.

10. The system of claim 1, wherein the supplemental data comprises further entries of the partial lexicon that are stored in the non-volatile memory unit, and wherein obtaining the supplemental data comprises:
retrieving, from the non-volatile memory unit and into the volatile memory unit, a further entry of the partial lexicon containing a mapping from the path to: (i) a particular file of the sequence of files, and (ii) a particular offset within the particular file that identifies the element.

11. The system of claim 10, wherein the further entries of the partial lexicon are stored in the non-volatile memory unit based on the further entries of the partial lexicon being associated with paths that identify elements that are nested within more than a threshold number of parent elements.

12. The system of claim 11, wherein the threshold number of parent elements is within a range of 2 to 4.

13. The system of claim 11, wherein retrieving the further entry comprises:
determining that the path indicates that the element is nested within more than the threshold number of parent elements; and
in response to determining that the path indicates that the element is nested within more than the threshold number of parent elements, reading, from the non-volatile memory unit and into the volatile memory unit, a lexicon file that contains the further entry.

14. The system of claim 10, wherein the operations also include:
after providing the element, deleting the further entry from the volatile memory unit.

15. The system of claim 1, wherein the volatile memory unit is a main memory unit, and wherein the non-volatile memory unit is a disk-based memory unit.

16. A computer-implemented method comprising:
receiving, by a computing system, a specification of a path, wherein a non-volatile memory unit of the computing system stores a sequence of files, wherein content within the sequence of files collectively represents structured data from a file or data stream, wherein elements within the structured data are uniquely identified by respective paths, wherein a volatile memory unit of the computing system stores a partial lexicon, wherein entries within the partial lexicon map at least some of the respective paths to the sequence of files and offsets therein, and wherein the offsets identify the elements that correspond to the respective paths;
determining, by the computing system, that the partial lexicon does not contain a mapping for the path;
in response to determining that the partial lexicon does not contain the mapping for the path, obtaining, by the computing system and into the volatile memory unit, supplemental data for the partial lexicon, wherein the supplemental data identifies an element that corresponds to the path; and
providing, by the computing system for display, storage, or further processing, at least part of the element.

17. The computer-implemented method of claim 16, wherein obtaining the supplemental data comprises:
deriving a second path from the path, wherein the second path is a prefix of the path;
mapping, by way of the partial lexicon, the second path to a target file within the sequence of files and a target offset within the target file, wherein the target offset identifies a parent element that contains the element;
generating, from at least the target file, a partial document object model (DOM) tree for the parent element and all elements contained within the parent element; and
based on the path, finding, within the partial DOM tree, the element.

18. The computer-implemented method of claim 16, wherein the entries for the elements that are of a size less than a pre-determined threshold number of bytes are not initially stored in the partial lexicon.

19. The computer-implemented method of claim 16, wherein the supplemental data comprises further entries of the partial lexicon that are stored in the non-volatile memory unit, and wherein obtaining the supplemental data comprises:
retrieving, from the non-volatile memory unit and into the volatile memory unit, a further entry of the partial lexicon containing a mapping from the path to: (i) a particular file of the sequence of files, and (ii) a particular offset within the particular file that identifies the element.

20. An article of manufacture including a non-transitory computer-readable medium, having stored thereon program instructions that, upon execution by a computing system, cause the computing system to perform operations comprising:
receiving a specification of a path, wherein a non-volatile memory unit of the computing system stores a sequence of files, wherein content within the sequence of files collectively represents structured data from a file or data stream, wherein elements within the structured data are uniquely identified by respective paths, wherein a volatile memory unit of the computing system stores a partial lexicon, wherein entries within the partial lexicon map at least some of the respective paths to the sequence of files and offsets therein, and wherein the offsets identify the elements that correspond to the respective paths;
determining that the partial lexicon does not contain a mapping for the path;
in response to determining that the partial lexicon does not contain the mapping for the path, obtaining, into the volatile memory unit, supplemental data for the partial lexicon, wherein the supplemental data identifies an element that corresponds to the path; and
providing, for display, storage, or further processing, at least part of the element.
